(19) United States
(12) Patent Application Publication
(10) Pub. No.: US 2012/0227005 A1
(43) Pub. Date: Sep. 6, 2012

(54) TIME-DRIVEN EVENT SCHEDULING SYSTEMS AND METHODS

(75) Inventors: Jan R. ANTON, San Diego, CA (US); Brendan Boyd, San Diego, CA (US)

(73) Assignee: uTemporis, Inc., San Diego, CA (US)

(21) Appl. No.: 13/313,637

(22) Filed: Dec. 7, 2011

Related U.S. Application Data
(60) Provisional application No. 61/421,363, filed on Dec. 9, 2010.

(51) Int. Cl. G06Q 10/10; G06F 15/16; H04W 4/02; G06F 3/048

(52) U.S. Cl. 715/772; 705/7.19; 455/456.3

(57) ABSTRACT

Systems and methods described provide a mobile application or web-browser application that enables users to schedule personal activities through functionality that takes into account a user's calendar. The list of available events or activities may include a collection of events or activities that are available to the user within a geographical region that may be specified. The list of available events or activities may be displayed to the user according to the user's calendar, where applicable time slots, which may identified in the calendar as being free or otherwise available, may be populated by the list of available events or activities, and the user may view the list and pick one or more of the events or activities to attend

This application claims priority from provisional U.S. Patent Application No. 61/421,363, filed on Dec. 9, 2010, titled “Time-Driven Event Scheduling Systems and Methods,” and which is incorporated herein by reference in its entirety.

### BACKGROUND OF THE INVENTION

1. Field of Invention

Aspects of the present invention relate to event scheduling facilitated on mobile devices or desktop applications. More specifically, aspects of the present invention relate to time-driven event scheduling using mobile devices or desktop applications, and facilitated on the basis of calendar, content and/or personal preferences of a user.

2. Description of Related Art

Although there is a large number of applications for wireless devices, such as conventional smart telephones, that exist on the market, there is a marked need in the market for a mobile application, a web-browser hosted application, and/or a web client application that provides a user with the capability to schedule personal activities, events, and the like, on the basis of the user's calendar, instead of on the basis of mere content information accessible to the user via the wireless device. For example, users generally cannot select a period of time during which they are available to perform an activity or attend an event, and view events or activities that are available during that period of time, the events or activities being displayed to the user via a device. Most currently available conventional applications are content-driven and rely on use of categories of activities, for example, where a user must first select the category of activity they want to undertake, and then determine whether the activity is available for the period of time during which the user is available. These conventional systems and processes of displaying content by categories limit the choices of users because the various search results available to the users are only viewable within the category chosen, without taking into account the period of time during which the user is available. Accordingly, users traditionally have had to review multiple categories before decisions can be made, then choose a period of time during which to attend the event or activity, and then determine whether the categories are available for the chosen period of time, all of which produce a time consuming process. As a result, users today are typically forced to use separate applications for selecting events to attend, and then they must compare the time slots in which these chosen events are available to the free time slots, or any other applicable time slots, in a calendar. Consequently, a user must toggle back and forth from one application, such as a third party content aggregator or provider, to another application, such as a personal calendar, multiple times in order to schedule the event. Among other problems, this approach presents a long and tedious process.

### SUMMARY OF THE INVENTION

In light of the above described problems and unmet needs as well as others, aspects of the systems and methods described herein provide a mobile application or web-browser application that enables users to schedule personal activities through functionality that takes into account a user's calendar, e.g., a user's available time slot, a list of available local, regional and national events or activities, and a user's personal preferences. The list of available events or activities may include a collection of events or activities that are available to the user within a geographical region that may be specified by the user, for example. The list of available events or activities may be displayed to the user according to the user's calendar, where time slots identified in the calendar as being free may be populated by the list of available events or activities, and the user may view the list and pick one or more of the events or activities to accept.

According to various aspects of the current invention, a user may therefore be able to determine at a glance whether a given time slot that is free, or that is not currently free but may be available, may be spent performing an activity or attending an event that corresponds to the user's preferences. Data related to a user's personal preferences may be added to the device, either automatically or by the user, updated either automatically or by the user, and used as a basis to search an aggregate content of activities and available events. Thus, for example, should the user choose to view activities that are available and that correspond to the user's preferences, then the user's calendar may display, in the time periods that the user selects, time periods that are labeled as free in the user's calendar, or any time periods on the user's calendar even if the time periods have an event or appointment scheduled, any suitable activity available at that time. Accordingly, the user may select a time-driven activity or event.

According to various aspects of the current invention, a user may be able to select such time-driven events or activities on the basis of location, for example, or within a radius of a given location, the location being specified by the user or automatically detected by the device. The location may or may not correspond to the user's physical location at the time the user is scheduling an event.

Additional advantages and novel features of these and other aspects of the invention will be set forth in part in the description that follows, and in part will become more apparent to those skilled in the art upon examination of the following or upon learning by practice hereof.

### BRIEF DESCRIPTION OF THE DRAWINGS

Various example aspects of the systems and methods will be described in detail, with reference to the following figures, wherein:

FIG. 1 is a graphical representation of an icon representing an application illustrated on a smart phone platform, according to aspects of the current invention;

FIGS. 2-3 are graphical illustrations of an example sequence of time-driven scheduling events, according to various aspects of the current invention;

FIG. 4 is a graphical illustration of an example display of an event to the user, according to various aspects of the current invention;

FIG. 5 is a graphical illustration of an example display showing confirmation of a selected event for the user, according to various aspects of the current invention;

FIG. 6 is a flow chart illustrating a method for a time-driven scheduling process, according to various aspects of the current invention;

FIG. 7 is a graphical illustration of an example display of a calendar allowing the user to select events based on date information, according to various aspects of the current invention;

FIG. 8 is a graphical illustration of a display of an example plurality of time-driven events, according to various aspects of the current invention;

FIGS. 9-10 are graphical illustrations of example time-driven events scheduled on the basis of location, according to various aspects of the current invention;

FIG. 11 is a graphical illustration of an example time-driven event scheduled on the basis of user preferences, according to various aspects of the current invention;

FIGS. 12(a)-12(b) illustrate a display of an example user profile and user tips to facilitate the use of the device, according with various aspects of the current invention;

FIGS. 13(a)-13(c) illustrate example use of social networking according to various aspects of the current invention;

FIG. 14 is a graphical illustration of a display of an event taking place in a plurality of locations within a same area, according to various aspects of the current invention;

FIG. 15 presents an example system diagram of various hardware components and other features, for use in accordance with an aspect of the present invention; and

FIG. 16 is a block diagram of various example system components, in accordance with an aspect of the present invention.

### DETAILED DESCRIPTION

These and other features and advantages in accordance with aspects of this invention are described in, or are apparent from, the following detailed description.

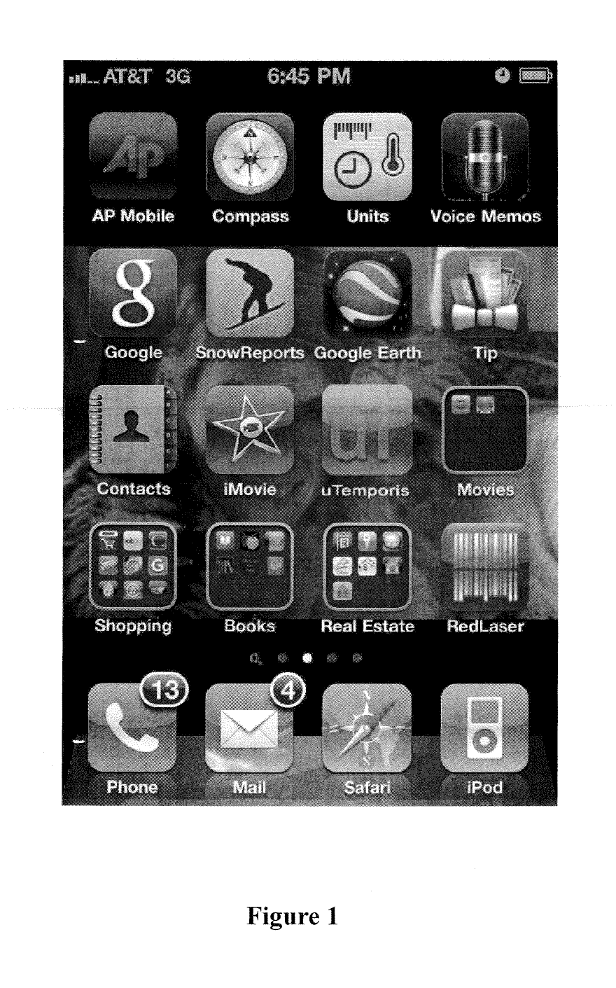

FIG. 1 is a graphical representation of the functional components of a mobile based platform, including an application according to aspects of the current invention. In FIG. 1, various applications are displayed on the display of a mobile device, such as a smart phone. Among the displayed applications, an application according to aspects of the current invention may be displayed.

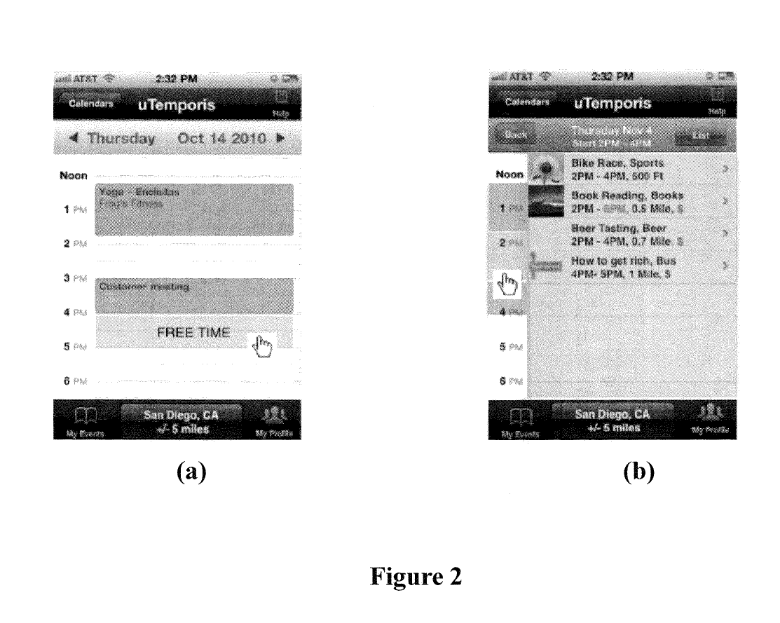

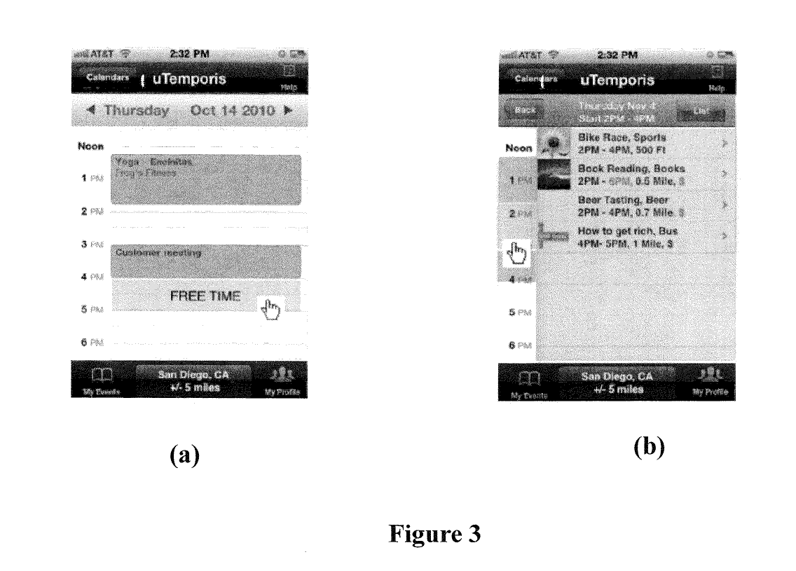

FIGS. 2-3 are graphical illustrations of a sequence of time-driven scheduling events, according to various aspects of the current invention. According to various aspects, a user may agree via, for example, a sign-up process, to automatically receive information related to activities or events of interest to the user and available during a time period either selected by the user or indicated on the user's calendar as being free. The user's calendar may be any commercial calendar operable on a device, for example, the device being a mobile device, a desktop computer, or the like. In FIGS. 2(a) and 3(a), the device displays a user's calendar and indicates, within the calendar, one or more periods of free time during which no events or activities are scheduled. In FIGS. 2(b) and 3(b), the user selects activities on the basis of the free time slots and possibly on the basis of the user's preferences which may have been previously set by the user or otherwise determined, such as via gathering of information about the user. For example, the user's preferences may be automatically determined based on the user's activities, internet activity such as internet searches, and the like. According to various aspects, the search results corresponding to activities or events may appear in a pop-up menu as the user hovers the cursor over the free time slot. According to various aspects, the user may select a time slot, such as a free time slot on the user's calendar, with the cursor or a mouse button, in order to view a window with all the search results, for activities available during that time slot and corresponding to the user's preferences, listed. The user may then scroll up or down the various search results to select one or more activities or events.

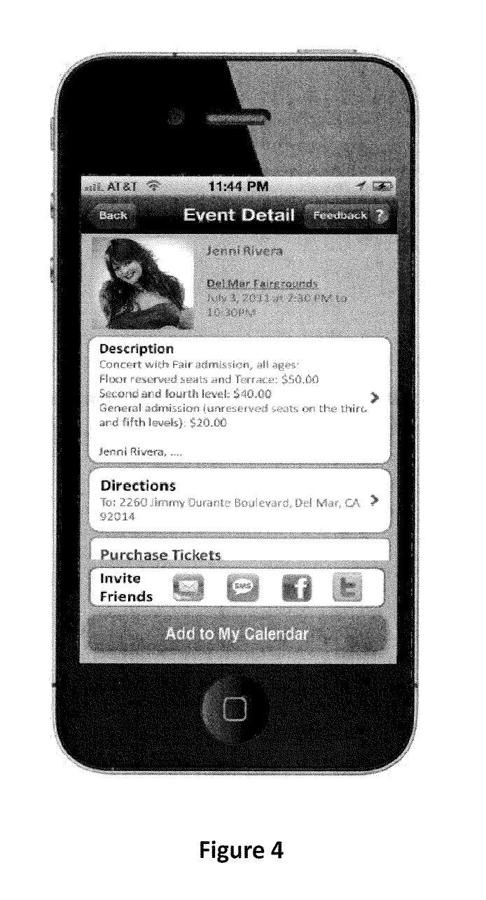

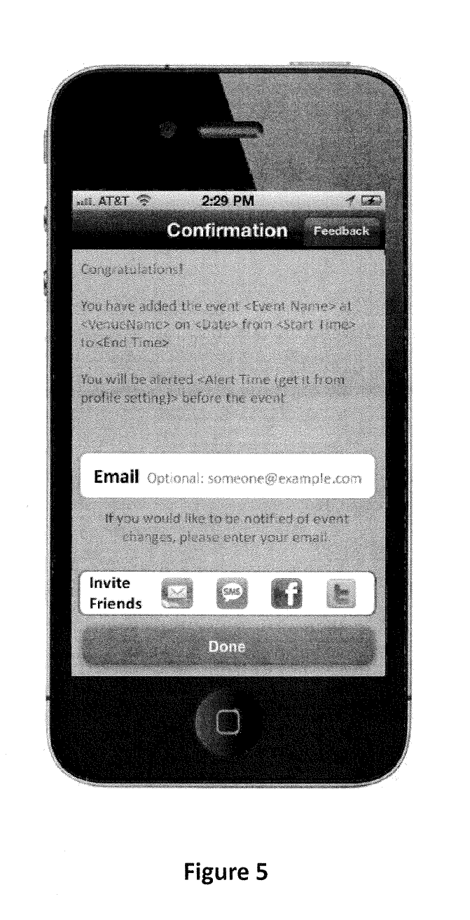

According to various aspects of the current invention, when a search result is selected by the user, for example, by clicking of the cursor on the display of the search result, via a voice-activated command or via any other suitable user input, the search result may be automatically included in the user's calendar. Alternatively, the user may enter the search result directly on the user's calendar via a keyboard of the device, a voice-activated command, or any other suitable input. It should be noted that user preferences may be stored on the device itself, or at a location remote from the device. In FIG. 4, a selected event is displayed to the user in more detail, where the device may indicating whether the event is free or whether the event comes at a price, and may display the price to the user on a window of the device screen. According to various aspects, FIG. 4 provides the user with the option of choosing from the search results, or saving the search result for a later decision. Once the user has selected an event, the user may receive a confirmation that the event has been scheduled, and FIG. 5 illustrates a confirmation that the event has been scheduled, the confirmation being displayed to the user.

According to various aspects of the current invention, the event organizing entity such as a concert hall or theater, may be in communication with the user's device wirelessly or via a communication link, such as via the Internet, for example. In such a case, the event may actually be scheduled remotely by using the user's device. For example, when the user confirms an event on the user's device, the event organizing entity, which may be communicatively coupled to the user's device, may receive and enter a reservation in the name of the user, or in another name chosen by the user. In addition, payment for the event, if applicable, may also be performed using the user's device communicatively coupled to the event organizing entity. For example, the user may be prompted via the device to enter a method of payment, such as a credit card, upon selection and reservation of an event. The above-discussed processes will be described in more detail below, in accordance with various aspects of the current invention.

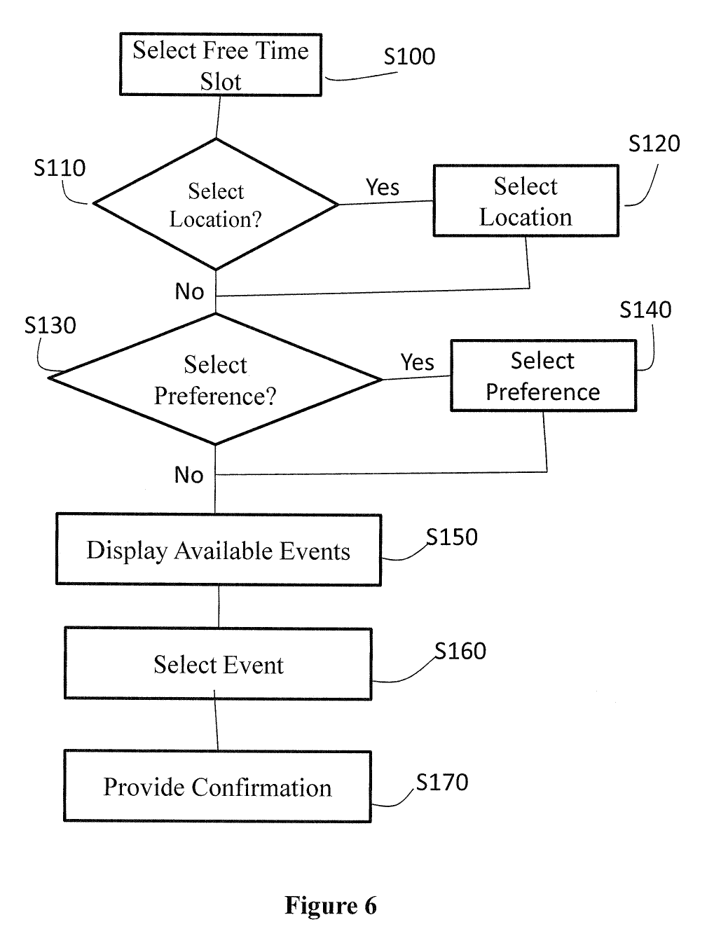

FIG. 6 is a flow chart illustrating an example method for a time-driven scheduling process according to various aspects of the current invention. In FIG. 6, the method starts at S100 where a user selects a free time slot using a mobile device, such as a smart phone, a personal digital assistant, a desktop, or any other suitable device that supports a calendar and that includes a software application according to aspects of the current invention. A free time slot is a time slot that does not have any activity or scheduled event, and which may be filled with an activity. For example, FIGS. 2(a) and 3(a) discussed above illustrate such a free time slot. Alternatively, the user may select any other time slot that is not currently free on the schedule and that has a scheduled event or appointment, in order to view available activities, for the possibility of choosing the available activity and cancelling the currently scheduled event or appointment. According to various aspects of this invention, S100 may be omitted, in that any free time slot on the user's calendar may be automatically selected for a search of activities corresponding to the user's preferences, the user's preferences being determined in advance and stored either on the user's device or at a location remote from, and in communication with, the user's device. Alternatively, any time slot that is not free may also be selected automatically as being available.

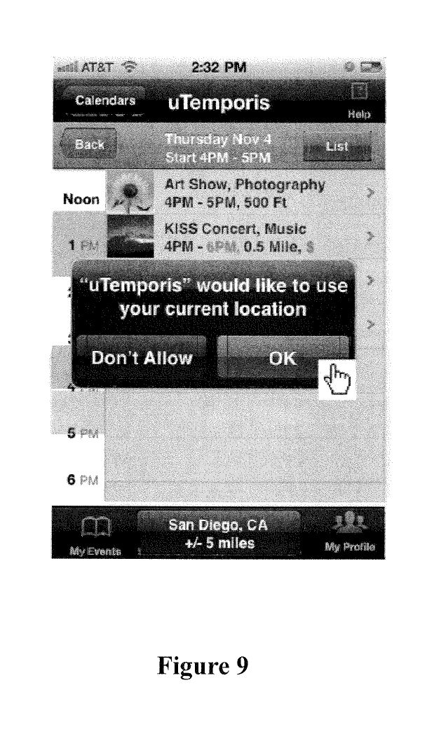

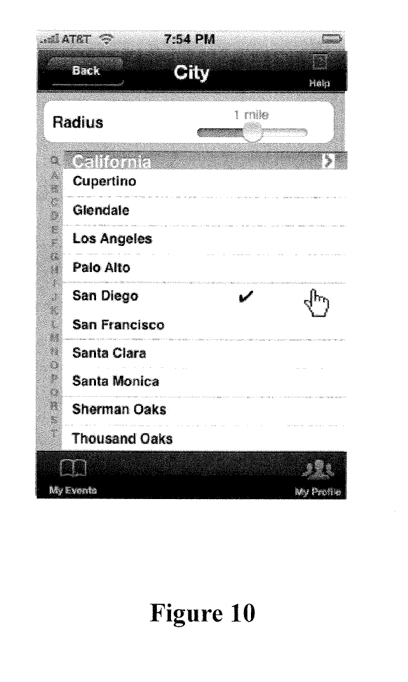

The method continues to S110, where the user may be prompted to select a location, according to various aspects. It should be noted that the user may also not be prompted to select a location, according to other aspects, in which case the user's current location, as determined automatically via for example a Global Positioning System (GPS) device and/or other features to locate the device, may be automatically selected. If the user wishes to select a location, then the method continues to S120, where a location is selected. According to various aspects, the location may be the location of the user at the time the user uses the application, or may be any other location of the user's choosing and entered by the user via the device. For example, the user may select a different location than their current location when the user is to travel to a different location at a later date or time and wishes to schedule an event for that later date or time. FIGS. 9-10 illustrate the selection by the user of a location, which may be the location of the user at the time of the selection or another location selected by the user. The user may also select a radius distance around the location selected, in order to provide more search results corresponding to the broader range provided by the radius.

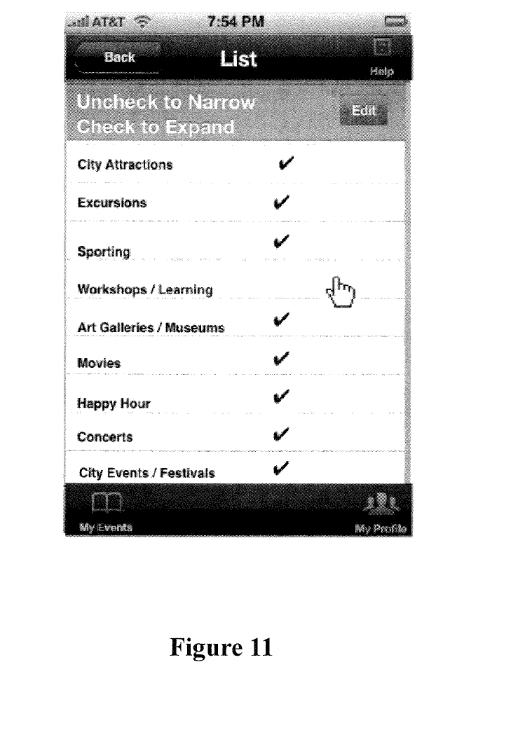

According to various aspects of the current invention, once the selection is selected, the method continues to S130, where the user is prompted to choose a preference. It should be noted that the user may also not be prompted whether or not to choose a preference. If the user desires to choose a preference, then the method continues to S140, where the user may select one or more preferences. For example, FIG. 11 illustrates the selection by the user of one or more preferences. According to various aspects, the user preferences may be previously stored either on the device or at a location remote from, and communicatively coupled to, the device. The user preferences may also be updated by the user by adding new preferences or by removing old preferences. If during S140 the user does not desire to choose a specific preference, then the method continues to S150, where available events that correspond to all the previously stored preferences of the user and that are available during the free time slot and the location may be displayed to the user. For example, FIGS. 2(b), 3(b) and 5 illustrate the presentation of the search results to the user via the user's calendar in the time slot selected by the user as being free.

After available events are displayed to the user at S150, the method continues to S160, where an event is selected by the user, such as is illustrated in FIG. 4. Optionally, once the event is selected, the method may continue to S170, where a confirmation may be provided to the user, as illustrated in FIG. 5. The device may also display price information, if the event is a paying event. According to various aspect of the current invention, should the event organizing entity be linked to the device wirelessly or via another communication coupling, such as via the Internet, for example, then the event may be scheduled and paid for via the device. According to various aspects, when the user selects an event, then the corresponding time slot may no longer be labeled as a free time slot on the user's calendar.

According to various aspects of the current invention, when a user selects a search result as discussed above with respect to S160, the event selected is saved on the user's calendar. Optionally, the user may receive updates on later occurrences of that same activity or event. For example, if a user has selected a concert by a specific performer on a given day and location, the user may receive, via text messaging, email communication, automated telephone message or other mechanism or method, information on future concerts of that same performer taking place in the same or nearby location, or other suitable location such as the location where the user currently is. Accordingly, the user may be kept regularly informed of occurrences of an activity or event corresponding to a search result that the user has once selected.

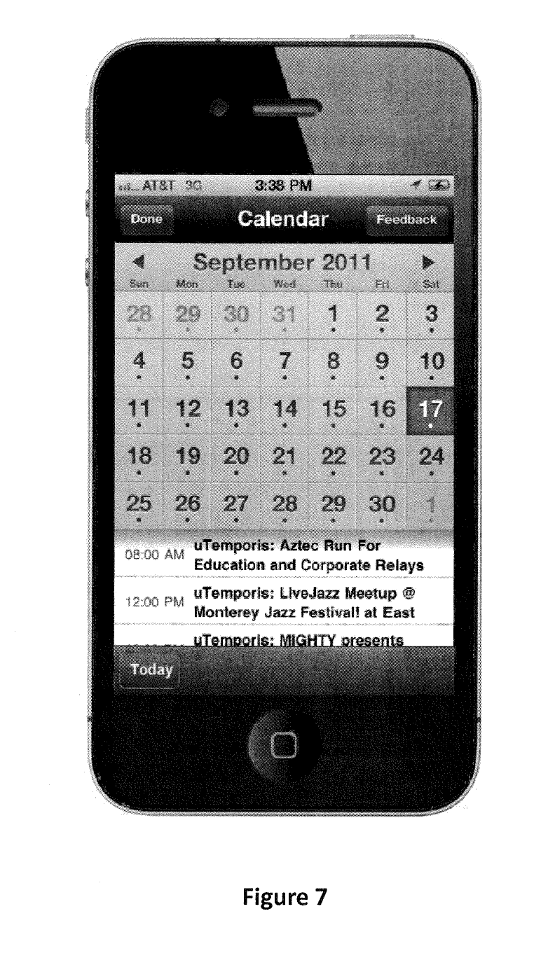

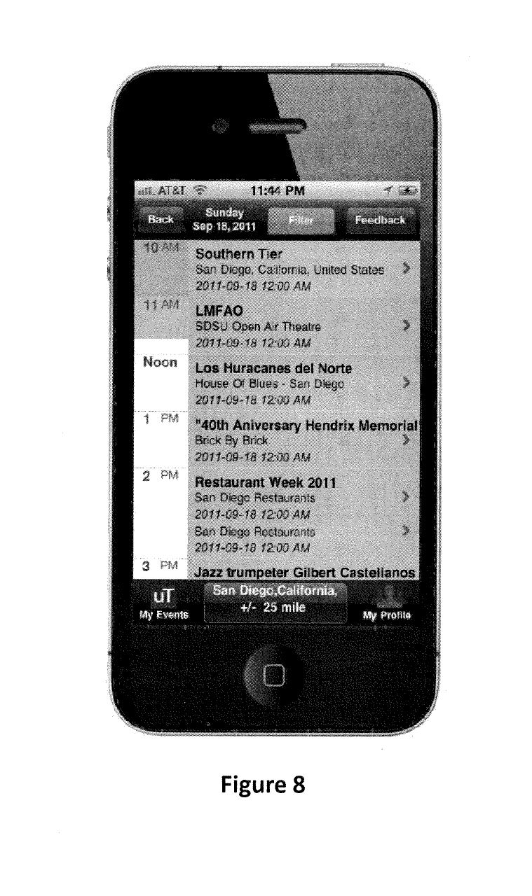

For example, FIG. 7 is a graphical illustration of an example display of a calendar allowing the user to select one or more events, and FIG. 8 is a graphical illustration of an example of time-driven scheduled events, according to various aspects of the current invention. When a user selects a given day from the calendar illustrated in FIG. 7, the user's device displays to the user one or more search results that may correspond to the user's selected available time period, preferences and location, for example, as illustrated in FIG. 8. When more than one search result is available, the user may scroll through all the available search results and choose a search result. It should be noted that although the user specifies a specific time period, the device may also display events or activities that correspond to that time period and to a portion of time prior to, and/or later than, the specified time period. For example, if the user specifies a free time period of between 2 and 4 pm, the device may display events that are available between 12 PM and 6 pm, a narrower range of time or a wider range of time. In addition, the device may display whether the event is a free event or whether the event is a paying event. According to various aspects, the device may also display a rating that may be generated by other users, or generated by one or more rating entity, and/or display a text field that may include an explanatory statement for the activity or event being displayed and offered. According to various aspects, an advertisement about the activity may be displayed to the user, for example, when the activity is originated or sponsored by a business, in which case the user may choose to receive advertisements or coupons directly from the business via the device.

According to various aspects of the current invention, the data corresponding to the user's selected time period and preferences, and provided to the user to be displayed on the user's device, may be collected from entities, such as businesses, entertainment centers, movie theaters, markets, and the like, where these entities may provide their information to the user or to the user's device. For example, these entities may agree to provide information relative to their available services in exchange for increased exposure to a user who could be a potential client. Small business, such as family-owned stores, local movie theaters, community enterprises, and the like, which may not be able or willing to afford large advertising campaigns, for example, may agree to provide their information to the device application in accordance with aspects of the current invention. Accordingly, a user may view the services provided by these entities if the services are available to be provided during the user-selected time periods, or during time slots indicated to be free on the user's calendar, for example. When one or more preferences of the user are stored in the device or at a remote location communicatively coupled to the device, then the available services or activities from the small businesses discussed above may be provided to the user when they correspond to the user's preferences. The entities may regularly update their information, which may be displayed on the user's device. For example, the entities may have an account accessible wirelessly or via a communication link, such as via the Internet, and may use the account to update information directly on the user's device.

Alternatively, for example, the data corresponding to the user's selected time period and user's preferences, and provided to the user to be displayed on the user's device, may be collected via large content aggregator sources, such as websites, newspapers, and the like. The data may be stored in a data repository, or may be queried directly from the source whenever a user requests the data, such as by selecting a free time slot in the user's calendar. For example, if the source of data is a website, whenever a user requests data corresponding to a selected free time period, the system may perform a query of the website, the query selecting items, such as events, activities, and the like, that are available for the applicable time period and that correspond to the user's previously entered preferences.

According to various aspects of the present invention, a user's preferences may include the type of activities enjoyed, such as museums, art galleries, night clubs, happy hour bars, sporting events, movies, city attractions, spas, resorts, parks, natural reserves, restaurants, and the like. Thus, for example, only restaurants that offer preferred types of cuisine may be displayed on the calendar or display device of the user, instead of any other restaurant that happens to be located near the user-designated location. Accordingly, the user may avoid to being overwhelmed by too large of a number of search results. The user may similarly receive only search results that correspond specifically to the designated time, location, and preferences. It should be noted that the user's device, which contains the user's calendar, may include a GPS device and/or other features to locate the device, so that inputting a location in the device may not be necessary to receive available search results. However, the user may input other locations, different from the user's current location, and obtain relevant search results for such other location, for example.

According to various aspects of the present invention, if no activities or events are available for the time period selected by the user, then the device may display events and activities that correspond to the user's preferences for time periods adjacent to the selected time period, and the device may display alternative dates and times. The user may select any of the proposed activities or events for the alternative time periods, and may purchase or make a reservation for that event at the later time, for example. The user may also de-select or cancel a proposed event and/or activity from the calendar. Alternatively, the user may save a proposed event or activity for a later time. The user may also perform other functions, such as notifying friends and/or family about an activity or event and forwarding the selected event or activity to the friends and/or family wirelessly or via a communication link, such as the Internet. Such family and/or friends may or may not be users of devices operating in accordance with aspects of the current invention.

According to various aspects of the present invention, the user may not be required to select a specific time slot that is free, and all time slots that are designated as free on the user's calendar within a defined period of time such as, for example, one or two days to a few weeks, may be automatically populated with activities or events that correspond to the user's preferences. Further, alternative events may be selectable, even for time slots that are not free. Accordingly, the user may simply consider the calendar and determine whether the user is interested in any of the activities displayed for the time applicable slots.

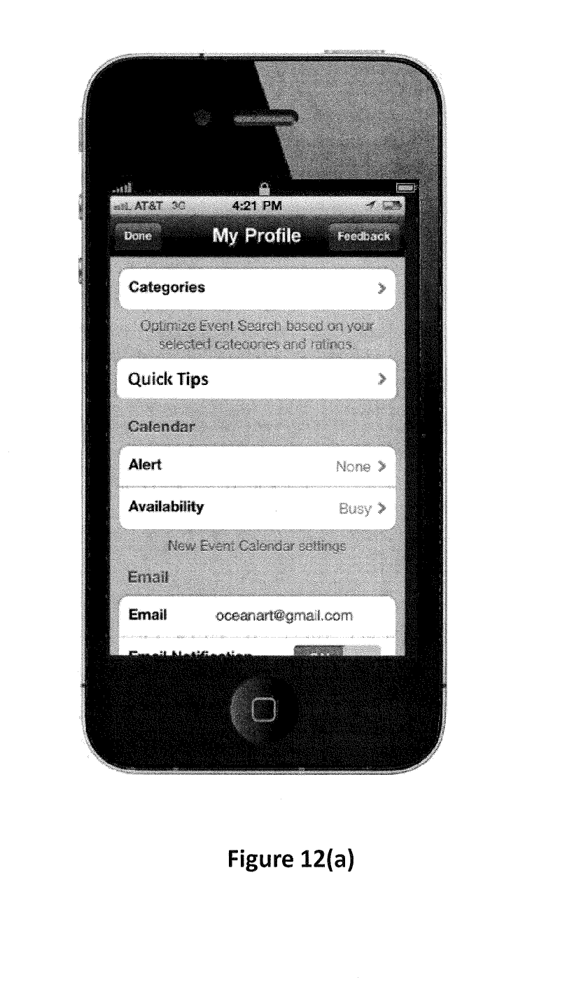

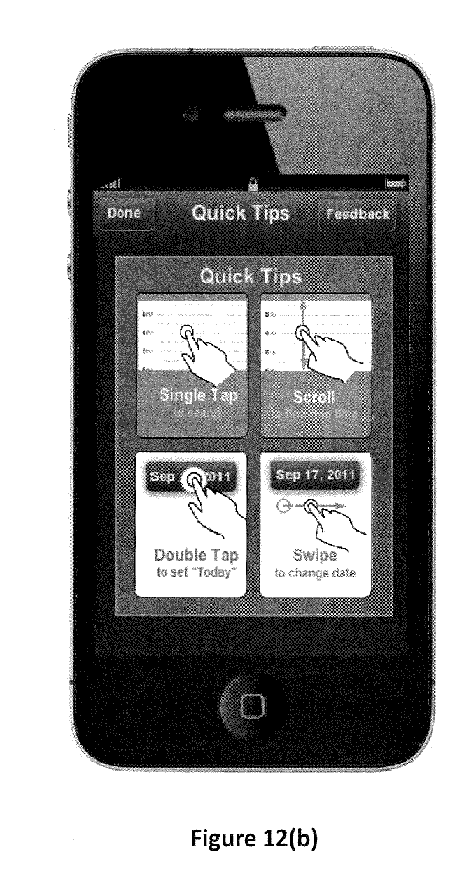

According to various aspects of the present invention, the user may define and store a profile, the profile including the user's preferences organized by categories of activities, along with alerts and availability, as illustrated in FIG. 12(a). According to various aspects, the device may display user tips to facilitate the use of the device for the user, as illustrated in FIG. 12(b). For example, the device may illustrate tips on how to rapidly access the user's calendar, to search for available events and/or to select desired events.

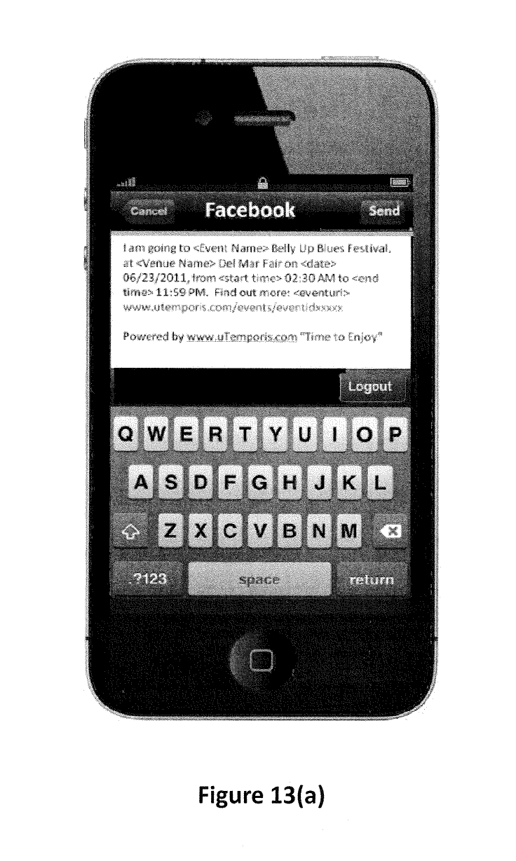

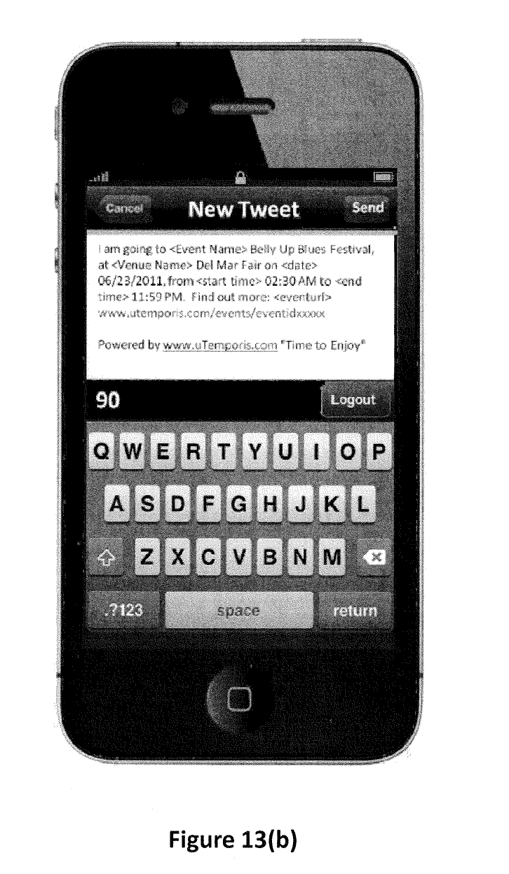

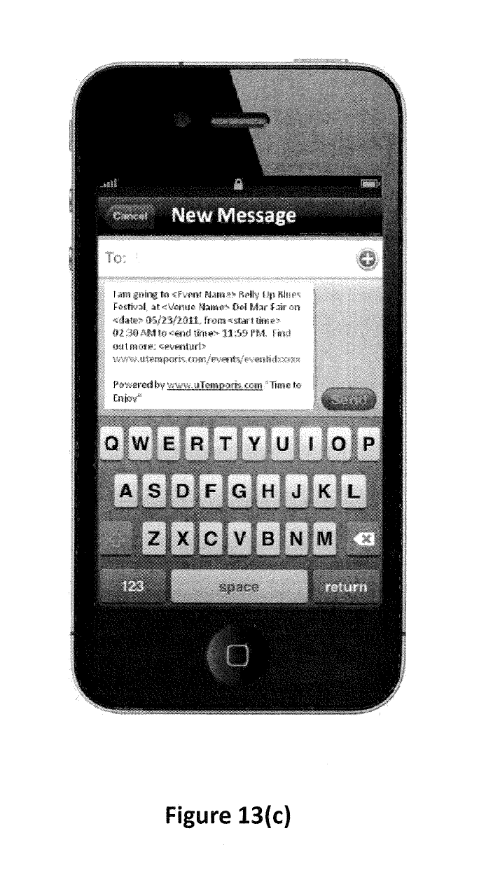

According to various aspects of the present invention, the user may inform other users, such as family and friends, of any events selected by the user, for example, to generate an interest in the selected event and induce one or more of the family and friends to also join the event. In order to inform the family and friends of the selected events, the user may use any available social networking tools, such as the social networking tools illustrated on FIGS. 13(a)-13(c).

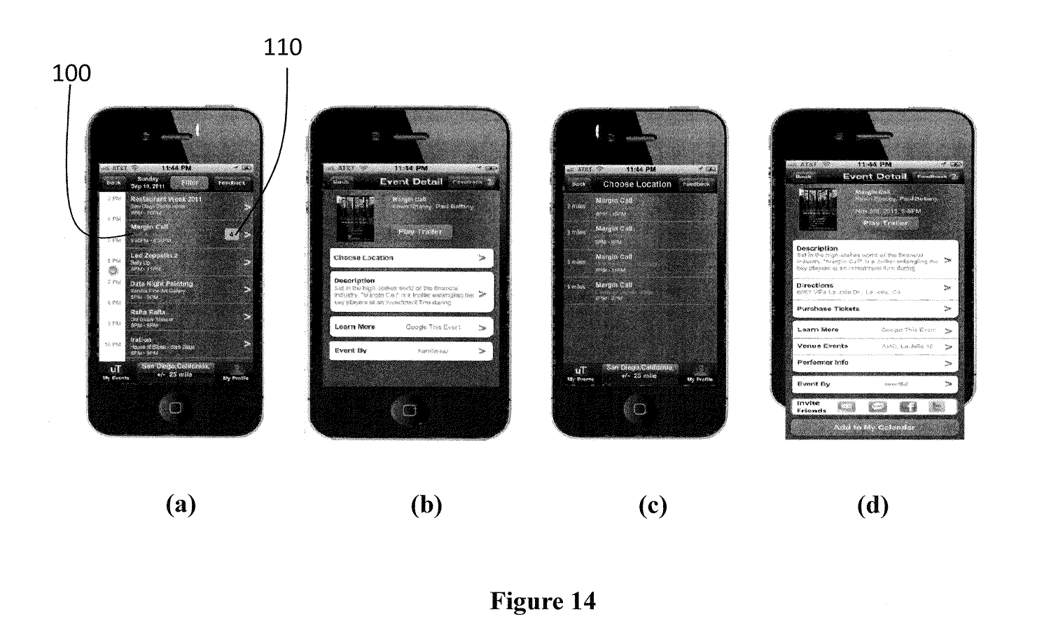

According to various aspects of the present invention, in the case of an event taking place at multiple locations within a same area, such as a movie being shown in several movie theaters, the user may be provided with a listing of the event, together with a number of times the event takes place in the same area. FIG. 14 is a graphical illustration of An example display of an event taking place in a plurality of locations within a same area, according to various aspects of the current invention. FIG. 14(a) illustrates a list of a plurality of events displayed to the user, according to various aspects. FIG. 14(a) also illustrates that one of the items on the list, labeled 100, is a movie, and the listing of the movie may be followed by an icon 110 indicating the number of places within a given area that the movie is showing. In the example of FIG. 14(a), the listed movie 100 is showing in four (4) different places, according to the label 110, and in FIG. 14(b), the user may review details about the movie or event as discussed in various examples above. According to various aspects, in FIG. 14(c), the user may review the various locations where the movie or event is showing, for example, by selecting item 100 on the list illustrated in FIG. 14(a). When the user selects item 100, then the plurality of locations may be displayed to the user as illustrated in FIG. 14(c). The user may then select one of the locations, and details of the specific location together with address, show times, and other relevant information, for example, may be displayed to the user as illustrated in FIG. 14(d).

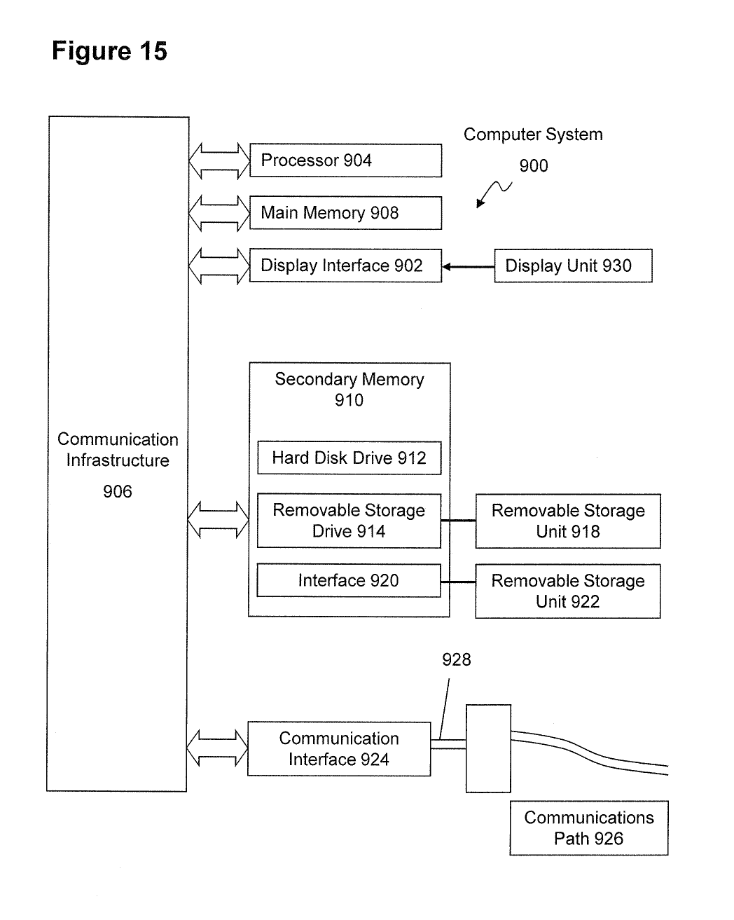

FIG. 15 presents an example system diagram of various hardware components and other features, for use in accordance with aspects of the present invention. Variations of the present invention may be implemented using hardware, software, or a combination thereof and may be implemented in one or more computer systems or other processing systems. In one variation, aspects of the invention are directed toward one or more computer systems capable of carrying out the functionality described herein. An example of such a computer system 900 is shown in FIG. 15.

Computer system 900 includes one or more processors, such as processor 904. The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement aspects of the invention using other computer systems and/or architectures.

Computer system 900 may include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. Aspects of the invention are directed to such computer program products.

Computer programs (also referred to as computer control logic) are stored in main memory 908 and/or secondary memory 910. Computer programs may also be received via communications interface 924. Such computer programs, when executed, enable the computer system 900 to perform various features in accordance with aspects of the present invention, as discussed herein. In particular, the computer programs, when executed, enable the processor 910 to perform various features in accordance with aspects of the present invention. Accordingly, such computer programs represent controllers of the computer system 900.

In an aspect of the invention implemented using software, the software may be stored in a computer program product and loaded into computer system 900 using removable storage drive 914, hard drive 912, or communications interface 920. The control logic (software), when executed by the processor 904, causes the processor 904 to perform various functions as described herein. In another variation, aspects of the invention are implemented primarily in hardware using, for example, hardware components, such as application specific integrated circuits (ASICs). Implementation of the hardware state machine so as to perform the functions described herein will be apparent to persons skilled in the relevant art(s).

In yet another variation, aspects of the invention are implemented using a combination of both hardware and software.

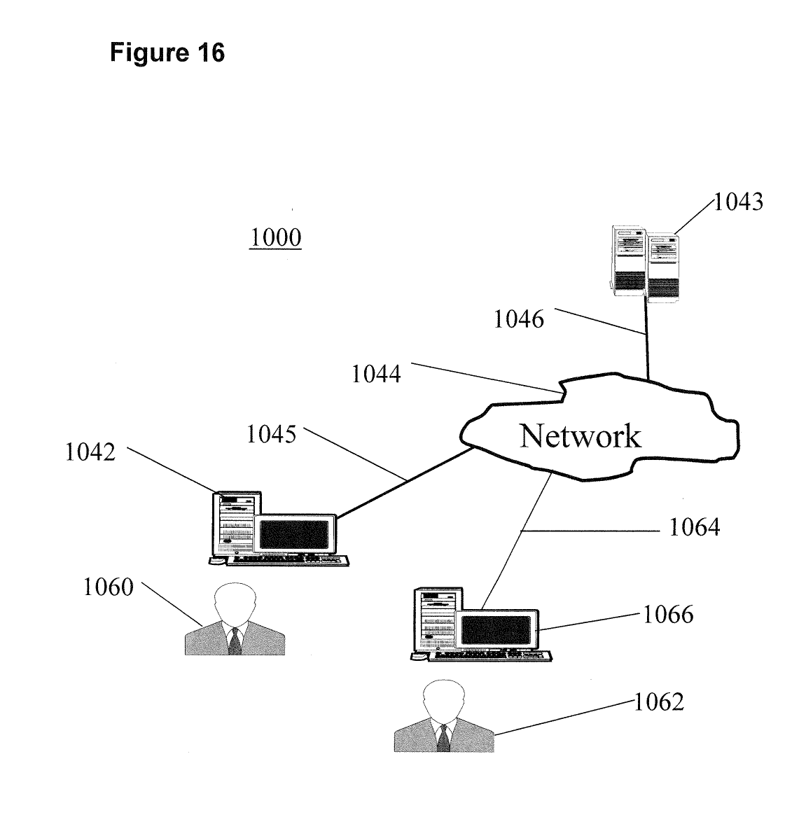

FIG. 16 is a block diagram of various example system components, in accordance with an aspect of the present invention. FIG. 16 shows a communication system 1000 usable in accordance with the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060, 1062 via terminals 1042, 1066, such as personal computers (PCs), minicomputers, mainframe computers, microcomputers, telephonic devices, or wireless devices, such as personal digital assistants (“PDAs”), including smart phones, or other hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another variation, the method and system in accordance with aspects of the present invention operate in a stand-alone environment, such as on a single terminal.

While aspects of this invention have been described in conjunction with the example features outlined above, various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and scope hereof. Therefore, aspects of the invention are intended to embrace all known or later-developed alternatives, modifications, variations, improvements, and/or substantial equivalents.

What is claimed is:

1. A computer-assisted method of time-driven scheduling for a user, the computer having a processor, the method comprising:
populating a database on the basis of preferences of the user;
determining an applicable time slot in the user's schedule;
determining, via the processor, one or more of the preferences that are available during the applicable time slot; and
providing the determined one or more preferences to the user.

2. The method of claim 1, wherein the determined one or more preferences are provided to a wireless device of the user.

3. The method of claim 2, further comprising prompting the user to select one of the determined preferences to fill the applicable time slot.

4. The method of claim 1, wherein populating the database comprises receiving data from a searchable data source.

5. The method of claim 2, wherein determining an applicable time slot in the user's schedule comprises one selected from a group consisting of automatically determining the applicable time slot and having the user determine the applicable time slot.

6. The method of claim 5, wherein the user determines the applicable time slot by selecting a time slot in the user's schedule.

7. The method of claim 2,
wherein the preferences of the user are organized in categories; and
wherein providing the user with the determined one or more preferences comprises providing one or more categories that correspond to the one or more preferences.

8. The method of claim 2, wherein providing the determined one or more preferences to the user's wireless device comprises displaying the determined one or more preferences on a screen of the user's wireless device

9. The method of claim 2, wherein providing the determined one or more preferences comprises providing a cost of choosing each of the one or more preferences.

10. The method of claim 3, wherein, when the user selects at least one of the determined preferences to fill the applicable time slot, a communication is initiated with a provider of the selected at least one of the determined preferences to at least one selected from a group consisting of effecting payment and making a reservation for the selected at least one of the determined preferences.

11. The method of claim 11, further comprising:
receiving a confirmation of at least one of the effected payment and of the making of the reservation for the selected at least one of the determined preferences from the provider of the selected at least one of the determined preferences; and
providing the confirmation to the user.

12. The method of claim 2, wherein determining one or more of the preferences that are available during the applicable time slot comprises:
determining a geographical location; and
determining preferences that are available in the vicinity of that geographical location.

13. The method of claim 12, wherein determining the geographical location comprises one of determining a location via one of a global positioning system and a selection by the user.

14. The method of claim 1, wherein the applicable time slot comprises a free time slot.

15. A system for time-driven scheduling for a user, the system comprising:
means for populating a database on the basis of preferences of the user;
means for determining an applicable time slot in the user's schedule;
means for determining one or more of the preferences that are available during the applicable time slot; and
means for providing the determined one or more preferences to the user.

16. A computer program product comprising a non-transitory computer usable medium having control logic stored therein for causing a computer to perform time-driven scheduling for a user, the control logic comprising:
first computer readable program code means for populating a database on the basis of preferences of the user via the processor;
second computer readable program code means for determining an applicable time slot in the user's schedule;
third computer readable program code means for determining one or more of the preferences that are available during the applicable time slot; and
fourth computer readable program code means for providing the determined one or more preferences to the user.

17. A system for time-driven scheduling, the system comprising:
a processor;
a user interface functioning via the processor; and
a repository accessible by the processor; wherein
a database is populated on the basis of preferences of the user via the processor;
an applicable time slot in the user's schedule is determined;
one or more of the preferences that are available during the applicable time slot are determined; and
the determined one or more preferences are provided to the user.

18. The system of claim 17, wherein the determined one or more preferences are provided to a wireless device of the user.

19. The system of claim 18, wherein the wireless device comprises one of a personal digital assistance, a portable computer, and a smart phone.

20. The system of claim 17, wherein the processor is housed on a terminal selected from a group consisting of a personal computer, a minicomputer, a main frame computer, a microcomputer, a hand held device, and a telephonic device.

21. The system of claim 17, wherein the processor is housed on a server selected from a group consisting of a personal computer, a minicomputer, a microcomputer, and a main frame computer.

22. The system of claim 21, wherein the server is coupled to a network via a coupling.

23. The system of claim 22, wherein the network is the Internet.

24. The system of claim 17, wherein the repository is housed on a server.

25. The system of claim 24, wherein the server is coupled to a network via a coupling.
